(19) United States
(12) Patent Application Publication
(10) Pub. No.: US 2015/0089980 A1
(43) Pub. Date: Apr. 2, 2015

(54) Locking System

(71) Applicant: Richard Beck, Round Corner, NW (AU)

(72) Inventors: Cary Maguire, Chicago, IL (US); Nicholas Eccles, Chicago, IL (US); Dickory Rudduck, Round Corner (AU)

(21) Appl. No.: 13/819,359

(22) PCT Filed: Aug. 27, 2011
(86) PCT No.: PCT/AU11/01106

§ 371 Date: Sep. 30, 2014

Related U.S. Application Data
(60) Provisional application No. 61/377,745, filed on Aug. 27, 2010.

(51) Int. Cl. E05B 65/02

(52) U.S. Cl. CPC E05B 65/025
USPC 70/101

(57) ABSTRACT

The invention provides a locking system which has at least one compartment 12 with one or more walls 13, 14, 15 and 16 defining an opening 18. There is a closure 24 for the opening 18. A fastener 22 is adapted to hold the closure 24 in a closed position relative to the opening 18 and adapted to allow the closure 24 to assume an open position relative to the opening 18 upon receipt of a suitable signal. A rail 20 is located in relation to the compartment 12. The fastener 22 is located along the rail 20.

### FIELD OF THE INVENTION

This invention is concerned with a locking system. In particular, this invention relates to a locking system positioned on a rail and capable of easy installation and removal.

### BACKGROUND OF THE INVENTION

Arrays of lockers or similar enclosures or compartments are widely known and found in a variety of locations, such as in schools, public transportation depots, shopping malls, etc. There is a high demand to provide people with a location to secure personal belongings, deliveries, etc.

Most locker systems in use utilize a key lock, a combination lock, or a similar manual locking system for providing security to the locker space. The problem is that keys are often lost and combination codes are forgotten, thereby locking a user out of accessing his/her belongings. Therefore there is a demand for a keyless and combination free solution to locking an enclosure. There have been many improvements in providing keyless access to lockers; however, the problem is that many currently existing locker systems cannot be easily retro-fitted with new keyless, electronic locks.

Many systems utilize electronic locks that are bulky and take up valuable space within the locker for the locking components and related electronics. Further, if the electronic lock fails, it is difficult to remove to repair or replace the lock without damaging the locker.

It is an object of this invention to overcome or at least substantially ameliorate the existing problems by providing a locking system which can be positioned on a rail in relation to a locker or compartment.

### SUMMARY OF THE INVENTION

Accordingly, this invention provides a locking system including:
at least one compartment having one or more walls and an opening defined by at least one of the walls;
a closure for the opening;
a fastener adapted to hold the closure in a closed position relative to the opening and adapted to allow the closure to assume an open position relative to the opening upon receipt of a suitable signal; and
a rail located in relation to the compartment;
wherein the fastener is located along the rail.

Preferably, the compartment is a locker or enclosure, which forms part of an array of lockers or enclosures, each having one or more walls and an opening defined by at least one of the walls, a closure for the opening and a fastener as disclosed above. In such an array, the compartments may be of the same size and shape or may differ in size and/or shape.

For convenience in the description below the compartment will be described in the context of an array, but it is to be understood that the invention is not limited to this embodiment, The locking system of the invention may have one, two or more compartments.

The closure is preferably a flap or door fitting the opening, but may take other forms. As one non-limiting example, the closure may be a drawer.

The fastener preferably includes material adapted to contract when activated, such as the radial type fastener disclosed in U.S. Pat. No. 7,610,783, the contents of which are incorporated herein by reference. One skilled in the art will appreciate that other fastener forms may be equally suitable. The material adapted to contact when activated is preferably shape memory alloy wire. Shape memory alloys are known and are usually made predominantly or wholly of titanium and nickel, They may also include other material, such as aluminum, zinc and copper. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again.

In connection with the preferred fastener of the present invention, it is preferred that the shape memory alloy contracts when heated in situ, Shape memory alloy wire currently available, such as that sold under the trade mark Nitinol, is capable of contracting by about 3% when activated by heating.

Activation of the material adapted to contract when activated is preferably achieved through electrical resistance heating, with a wire feed to the fastener assembly. Activation of the shape memory alloy wire may be initiated from a central location, using a hard wiring system. it is also within the scope of this invention that the activation is initiated by remote means, for example, wirelessly or by using a hand held tool operating through the use of any suitable form of energy, including microwave, electromagnetic, sonic, infra-red, radio frequency and so on.

The scope of the invention in its various aspects is not necessarily limited to the use of shape memory alloy. Other material may also be useful. Also, while activation may take place through heating, other means of activation may be suitable and are within the scope of this invention.

The rail may be located in any desired position in relation to the compartment, including inside or outside the compartment.

In one preferred embodiment, the rail is located in a position inside a series of locking systems which are aligned vertically or horizontally, with a fastener for each compartment being mounted in or on the rail so that each fastener is in a position to hold the closure in the closed position or to permit or cause it to open. The rail preferably has a series of holes drilled out or formed in it for the fasteners. Using a standard, uniform rail can allow easy customization of an array of several compartments. If a fastener is not needed at a point along the rail, a bezel or other device may be used to cover the hole so that a neat appearance is presented

In a preferred embodiment, the locking system of the invention includes at least one indicium visible from outside the compartment, the indicium being adapted to provide a visual indication of a status of the locking system. For example, the indicium may indicate by a light or color, etc, whether the compartment is empty or occupied, whether the fastener is holding the closure in the closed position or not or whether the fastener is damaged or compromised in any way.

In order to indicate closed status of the closure or health of the fastener, the indicium may be joined to the fastener by a suitable means such as a serial cable interconnector or may communicate with it as required. One or more sensors may be used for these purposes instead. Sensors may also be used to detect whether a compartment is empty or occupied.

One skilled in the art will recognize that signals to and from the fastener and other monitoring capabilities can be transmitted wirelessly or through hard wiring via controlling electronics. Wireless transmission can occur through any acceptable means.

Preferably, the indicium is also mounted on or in the rail, there being one indicium for each compartment. If an indicium is not needed at a point along the rail, a bezel or similar can be used to cover the hole so that it is not seen.

It is further preferred that the locking system of the invention includes a user interface. A user interface may be located on the front of each compartment or there may be one user interface servicing a plurality of compartments, located, for example, in the vicinity of the plurality of compartments.

The user interface may take any suitable form but preferably is in the form of a keypad or computer touch screen. In this embodiment, the locking system of the invention may offer a user any number of choices for the use of a compartment. In one instance, a package may have been stored within the compartment by either that particular user or by a different user and the user now has a need to access the package. The user uses the touch screen to make a desired selection for activity (such as ‘open my compartment’).

The user interface will prompt for an access code or for an identifier device, such as an RED card. Only users with the proper access code or device will be granted access. Once the code or device is accepted, the interface will prompt the user as to the compartment that is to be accessed. The indicium, if present, may light up or change colour or blink to help the user identify the correct compartment. At the same time, a signal may be sent to the fastener from controlling electronics to unlock the closure and allow the user access into the compartment.

The locking system of the invention may include the ability to keep a log of events. For example, when the user takes the contents from the compartment, a log may be kept as to when/how the user accessed the compartment It is also possible for other events to be recorded, such as What was taken from the compartment (by measuring weights), how long the user took in accessing the compartment, etc. Any number of events may be monitored and stored by the electronics, depending on a user's needs.

In another instance, a user may wish to leave a package for a different user (‘recipient’) to pick up at a later time or date. The delivering user will encounter other options for the compartment. The delivering user will be prompted to enter an access code to enable the delivering user to access a compartment The delivering user may then be prompted to select the type of compartment that is needed to house the package (for example, large, medium or small in size, refrigerated or heated, etc.). Once that selection is made, a suitable compartment is opened for the delivering user, optionally indicated by the indicium. The delivering user places the package in the compartment and closes the closure.

An email or other type of electronic message may be sent via controlling electronics to the recipient user to notify that the package is ready for pickup.

In these embodiments, an administrator of the fastening system may be granted access to the or all compartments. This is particularly useful in emergency settings where is it imperative that a compartment is opened or in schools, for example, when teachers or other school officials must have access to a compartment.

In some situations, it may be desirable for an administrator or other authorised person to be provided with a manual option of accessing the compartments. If the software or electronics of the locking system of the invention were to fail, preventing a user from accessing a compartment's contents, one or more side panels of the compartment may be removable so that the rail can be manually unfastened from its mounting point. This action may be designed to free the rail and mounted fastener from the compartment and allows the compartment closure to open. This provides for minimal damage to the compartment and allows a user to easily retrieve compartment contents and also service the fastener.

One skilled in the art will recognize that the electronics may be in the form of a computer with appropriate software. The electronics may be one or more set of electronics arranged in a desired fashion to control the fastener and the locking system of the invention.

In an array of compartments, any number of compartments and rails may be used to make the desired configuration. If two compartments are located side by side, it is envisioned that the rail may divide the two compartments. Any empty space may be supported by spacer blockers. In another embodiment, the fastener and any related indicium may be mounted within the compartment supported by a hinge for an internal mount. In another embodiment, the rail may take the form of an aluminum extrusion which may be is placed in a position relative to the compartment opening, the fastener being located inside the compartment.

In another preferred embodiment, the compartment has more than one opening defined by at least two of the walls.

In this embodiment, the compartment has two access points. This embodiment is especially preferred for situations whereby deliveries are made from one side and collected from a second, more secure side with limited user access. An example is a data center or clean room whereby one access side has a different security or environmental requirement compared to the other side. This embodiment performs in the same manner as described above except that deliveries and pickups to the same compartment may be made from either side of the compartment.

Other advantages and aspects of the present invention will become apparent upon a consideration of non-limiting preferred embodiments described in connection with the drawings.

### PRIER DESCRIPTION OF THE DRAWINGS

FIG. 1 is a front elevation of an embodiment of an array of locking systems according to the invention;

FIG. 2 shows the array of FIG. 1, with closures removed to show rails with fasteners and indicia;

FIG. 3 is a side view of the array of FIG. 1;

FIG. 4 is a side view of the rail of FIG. 3, but being of indefinite length;

FIG. 5 is a cross-sectional view showing a fastener mounted on the rail;

FIG. 5A is a detailed view of the fastener of FIG. 5 in the closed or locked position;

FIG. 5B is a detailed view of the fastener of FIG. 5 in the open or unlocked position;

FIG. 6 shows in cross-section one of the rails of FIG. 2;

FIG. 7 shows in cross-section a second embodiment of rail being an aluminum extrusion;

FIG. 8 is a cross-sectional view of a third embodiment of rail, being hinged; and

FIG. 9 is a perspective view of an array of compartments, each having an opening on opposite sides of the compartment.

### DETAILED DESCRIPTION OF THE DRAWINGS

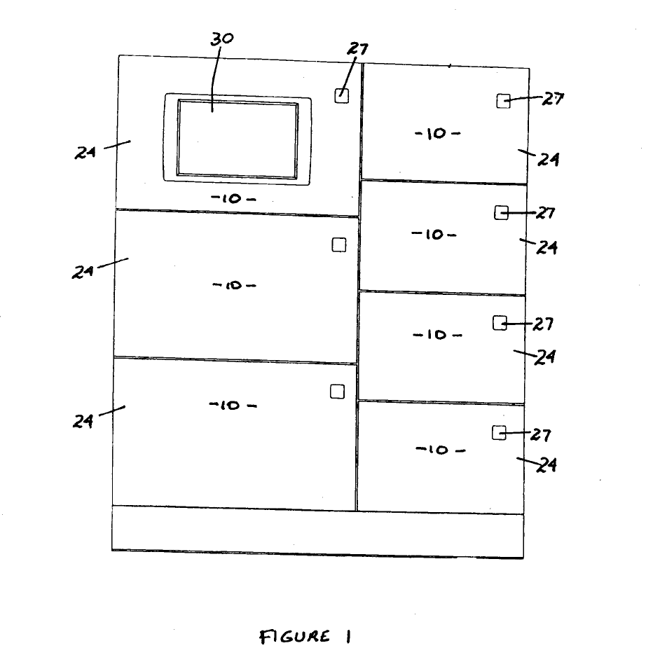

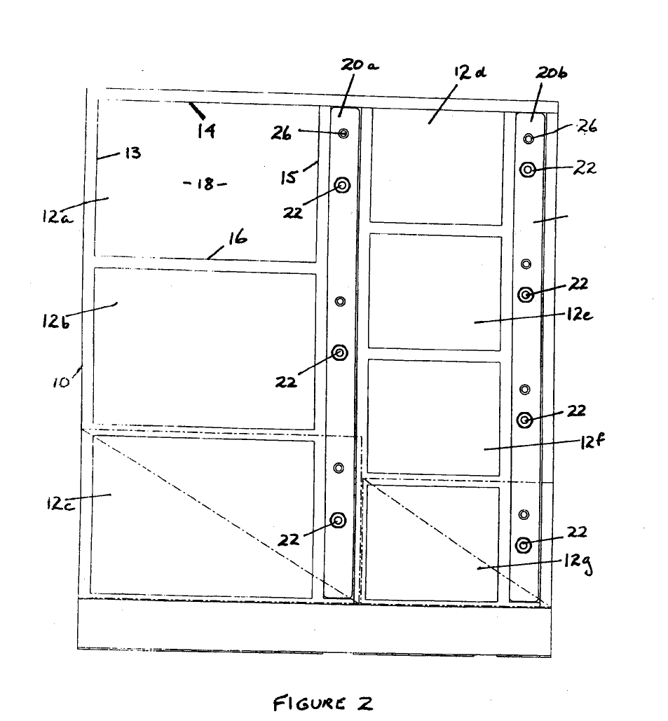

Referring first to FIGS. 1 to 3, each locking system 10 has a compartment 12. There is a first column of locking systems 10 having compartments 12a, 12b and 12e. There is a second column of locking systems 10 having compartments 12d, 12e, 12f and 12g, all of which are smaller than the compartments in the first column. Each compartment 12 (illustrated by compartment 12a in FIG. 2) has four side walls 13, 14, 15 and 16 and an opening 18 defined by the walls 13, 14, 15 and 16. Rail 20a is located at a position adjacent to compartments 12a, 12b and 12c, while rail 20b is located in a position adjacent to compartments 12d, 12e, 12f and 12g.

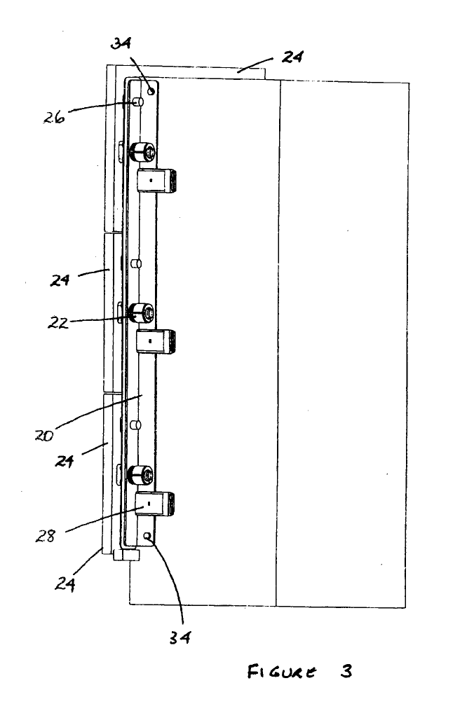

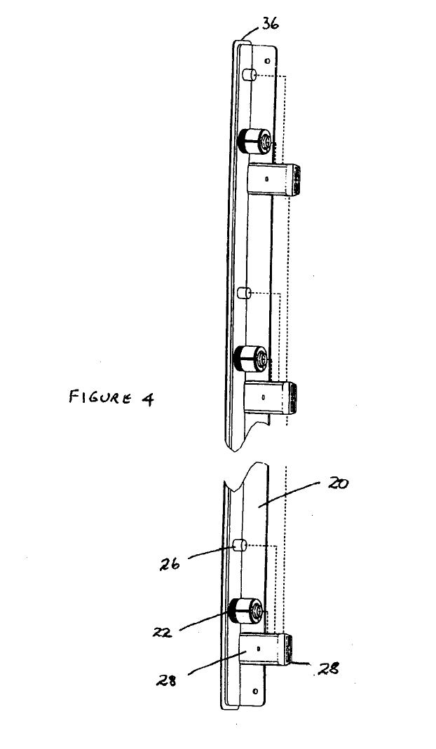

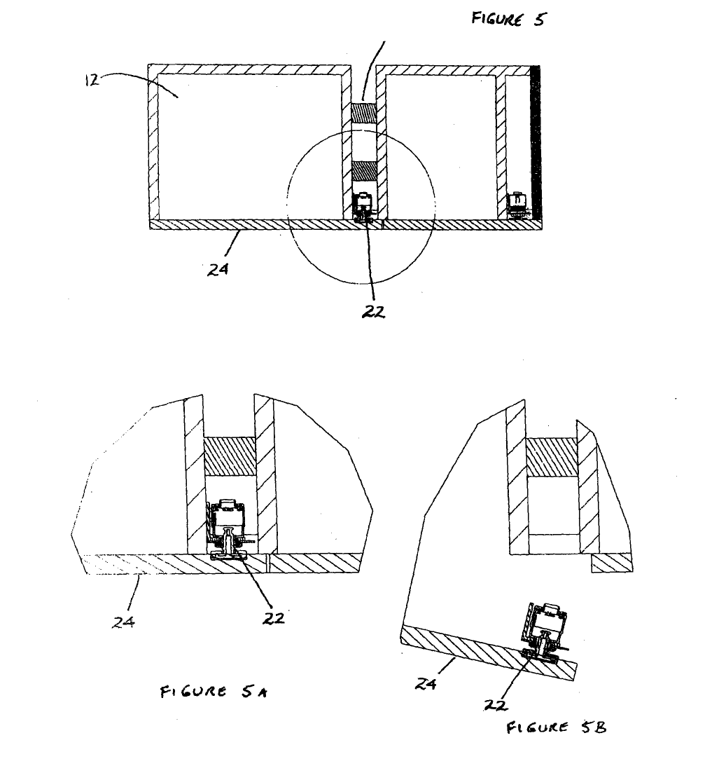

As best seen in FIGS. 2 and 3, each of rails 20a and 20b has a plurality of fasteners 22.

A fastener 22 for each compartment 12 is mounted in the rail 20 so that each fastener 22 is in a position to hold the closure 24 in the closed position or to permit or cause it to open.

Also mounted on rail 20 is a plurality of indicia 26, one for each compartment 12. The indicium 26 for a compartment 12 is visible from outside the compartment 12 through viewing window or bore 27 (FIG. 1) and can provide a visual indication of a status of the compartment 12.

FIG. 3 shows rail 20 bolted beside a series of compartments, using bolts 34.

As seen in FIG. 4, a serial cable interconnector 28 connects fastener 22 with indicium 26 for each compartment 12, so that fastener 22 and indicium 26 act in concert upon receiving a signal to lock or unlock.

Bezel or face plate 36 may be used to cover any holes not being occupied by fasteners 22 or indicia 26 or to further customize the appearance of rail 20. FIG. 1 shows a user interface 30 in the form of a touch screen for a computer (not shown). User interface 30 may service all of looking systems 10 in FIG. 1, or there may be a similar user interface 30 for each locking system 10.

In FIG. 6, rail 20a is shown located between two compartment walls 15 and 13, having a gap 38 between them. This gap or airspace can be weft to help keep the components of locking system 10 dry, since it allows air to circulate and any heat to dissipate. If desired, a fan (not shown) may be used to assist air flow in gap 38.

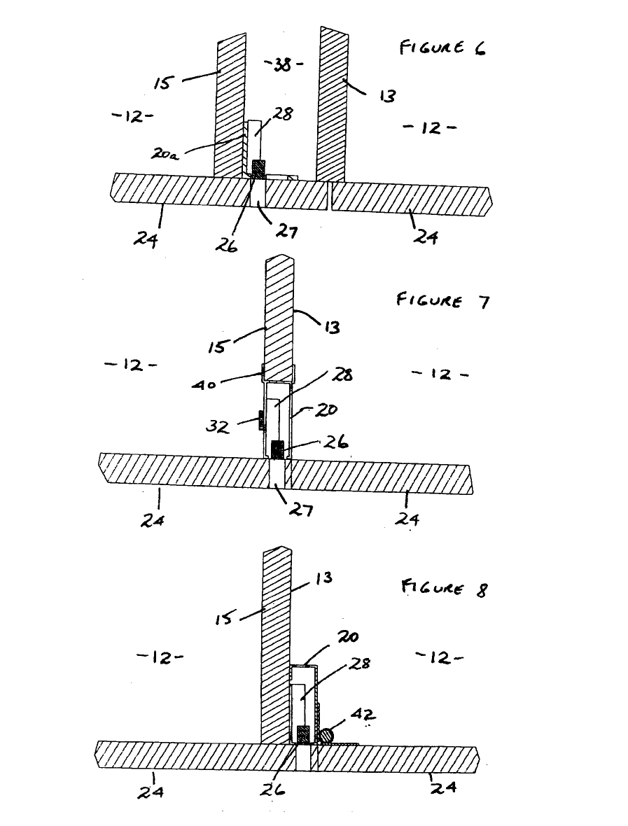

In FIG. 7, rail 20 takes the form of an aluminum extrusion which is useful to house indicium 26, fastener 22 (not shown) and interconnector 28. In this embodiment, rail 20 has bracket 40 into which a wall is fitted, the wall being a common wall between adjoining compartments, providing side wall 15 for the left-hand compartment 12 and side wall 13 for the right-hand compartment 12.

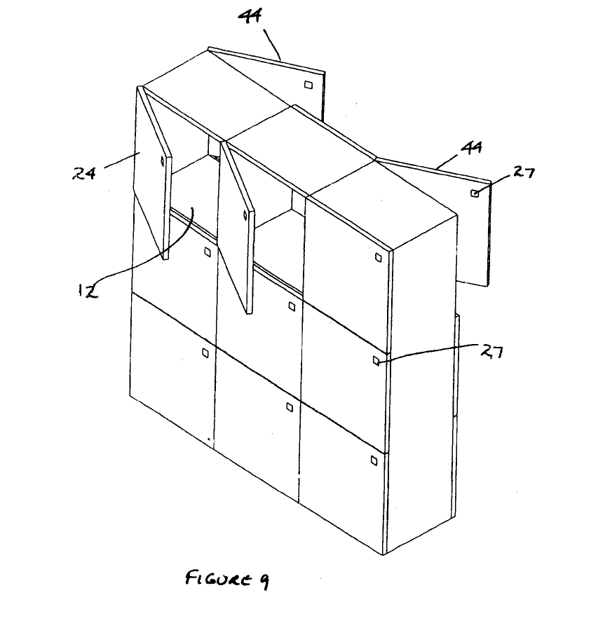

In FIG. 8, rail 20 is housed between common wall 15/13 and hinge 52.

Sensors 32, shown in FIG. 7, can be used in conjunction with the fastener 22 and/or indicium 26 to sense whether a compartment 12 is in use or not, the health of a fastener 22, or varying environmental factors surrounding the compartment 12,

FIG. 9 depicts another embodiment whereby each compartment 12 has two closures, in the form of door 24 on one side and door 44 on the opposite side. Either door 24 or door 44 may be used to access the interior of compartment 12. This arrangement is suitable for certain secured locations whereby user access is restricted on at least one side of the compartment 12. It will be appreciated that changes may be made to the embodiments described herein without limiting the spirit and scope of the invention.

### INDUSTRIAL APPLICABILITY

The locking system of the invention enables the use of fasteners which arc not bulky and which need not be installed within a storage compartment, taking up valuable space. Use of a rail can facilitate removal and repair of a failed fastener without damage to the compartment, since the rail can be removed from the locking system.

What is claimed is:

1. A locking system comprising:
at least one compartment having one or more walls and an opening defined by at least one of the walls;
a closure for the opening;
a fastener adapted to hold the closure in a closed position relative to the opening and adapted to allow the closure to assume an open position relative to the opening upon receipt of a suitable signal; and
a rail located in relation to the compartment;
wherein the fastener is located along the rail.

2. The locking system of claim 1, wherein the closure is a flap, door or drawer fitting the opening.

3. The locking system of claim 1, wherein the fastener includes material adapted to contract when activated.

4. The locking system of claim 1 wherein an indicium to indicate a status of the compartment is located on the rail.

5. The locking system of claim 1 wherein the rail is located in a void outside the compartment.

6. The locking system of claim 1, wherein the rail is located between adjoining compartments.

7. (canceled)

8. The locking system of claim 1 wherein the compartment has a second opening and a second closure therefore.

9. An array of locking systems as claimed in of claim 1.

10. The array of claim 1, wherein the compartments differ in size and/or shape.

11. (canceled)

12. (canceled)
